(19) United States
(12) Patent Application Publication
(10) Pub. No.: US 2026/0331616 A1
(43) Pub. Date: Oct. 22, 2026

(54) METHOD FOR SEPARATING LI IONS AND NA IONS

(71) Applicant: H. C. Starck Tungsten GmbH, Goslar (DE)

(72) Inventors: Juliane MEESE-MARKTSCHEFFEL, Goslar (DE); Armin OLBRICH, Seesen (DE); Alexander EGEBERG, Goslar (DE); Alexander ZEUGNER, Wolfenbüttel (DE); Alexander WOLFF, Hildesheim (DE)

(21) Appl. No.: 19/482,559

(22) PCT Filed: Jun. 5, 2024
(86) PCT No.: PCT/EP2024/065433

§ 371 Date: Nov. 7, 2025

(30) Foreign Application Priority Data
Jun. 9, 2023 (EP) 23178439.8

(51) Int. Cl. H01M 10/54; C01D 15/08; C22B 3/22; C22B 4/02; C22B 7/00; C22B 26/12; H01M 10/0525

(52) U.S. Cl. CPC H01M 10/54; C01D 15/08; C22B 3/22; C22B 4/02; C22B 7/007; C22B 26/12; H01M 10/0525

(57) ABSTRACT

The present invention relates to a process for separating Li and Na ions from sulfate-containing solutions, and a device for carrying out the process.

The present invention relates to a process for separating Li and Na ions from sulfate-containing solutions, and a device for carrying out the process.

Vehicles with electric drives that are driven by electric power from low-emission sources are attributed the highest climate protection potential among land-based transport technologies as seen throughout their life cycle. Accordingly, electromobility is considered a key component of a sustainable and climate-friendly traffic system based on renewable powers. The focus is on lithium ion/polymer batteries as a promising storage system as the basis of electric drive, which have only a limited service life, however. In this respect, the sought degree of electrification can be achieved only in combination with a sustainable recycling concept. In particular, the planned sales ban on new cars with internal combustion engines necessitates a holistic recovery of the valuable metals contained in the consumed batteries, such as cobalt, nickel and manganese, but also lithium, which is obtainable only by lengthy processes.

The prior art describes a number of methods that deal with the recovery of the valuable metals from consumed lithium ion/polymer batteries.

US 2017/0077564 relates to a process for recycling lithium-ion batteries, comprising: (i) identifying a molar ratio for cathode materials for a new battery; (ii) forming a leaching solution by combining comminuted battery material from a lithium battery recycling stream with an acidic leaching agent and hydrogen peroxide (H₂O₂) to separate cathode materials from undissolved materials; (iii) filtering the undissolved materials from the leaching solution formed, so that the dissolved salts of the cathode materials remain in the leaching solution; (iv) determining a composition of said leaching solution by identifying a molar ratio of the salts of the cathode material dissolved therein; (v) adding Ni, Co, Mn or Al salts as sulfates (xSO₄) based on the determined composition, in order to adjust the molar ratio of the dissolved cathode material salts in the leaching solution to correspond to the identified molar ratio for the recycled battery, including the addition of a solution of aluminum sulfates and a chelating agent; and (vi) increasing the pH of the leaching solution to at least 10 to precipitate and filter off metal ions of the cathode materials in order to form a precursor pCAM for the actual cathode active material CAM, in which the Ni, Co, Mn and Al salts remaining in the solution are present as a combined hydroxide (OH)₂ or carbonate (CO₃) with a molar ratio as desired for the new CAM. Subsequently, the precursor is thoroughly mixed with LiOH*H₂O or Li₂CO₃, and reacted to the cathode active material at temperatures of >800 °C.

US 2013/0302226 discloses a method for recycling batteries, in which a solution of aggregated battery materials is produced from consumed cells, impurities are precipitated from the solution produced, a predetermined ratio of desired materials is adjusted in the solution, and the desired material is precipitated and processed further into a cathode material for new batteries.

However, the methods described in the prior art have the disadvantage that, because of the nature of the process management, the lithium to be recovered is present as Li₂SO₄ in a solution together with Na₂SO₄, so that it can be recovered as sparingly soluble Li₂CO₃ only towards the end of the process chain. Because of the solubility relations of Li₂CO₃ and Na₂CO₃ as well as Na₂SO₄ and Li₂SO₄, a separation of Na and Li ions is very complicated in detail, and makes an actual quantitative recovery of lithium virtually impossible under economic aspects.

Thus, in order to achieve a sustainable and fully valuable recycling of consumed lithium ion/polymer batteries, there is still a need for a process that enables an improved recovery of lithium from Na-containing sulfate solutions. Thus, it has been the object of the present invention to satisfy this need.

Within the scope of the present invention, it has been surprisingly found that the poor separability of Li and Na ions from sulfate-containing solutions can be bypassed by a conversion to the corresponding hydroxides.

Therefore, the present invention firstly relates to a process for separating Na and Li ions, in which an aqueous solution A that includes Na₂SO₄ and Li₂SO₄ is subjected to electrolysis to obtain a solution B, and the solution B obtained is treated with a carbonate source to form Li₂CO₃.

Those skilled in the art are aware of the fact that the compounds Na₂SO₄, Li₂SO₄, Na₂CO₃, Li₂CO₃ and all the other salts are in the form of their ions in a solution. Therefore, unless designated otherwise, they are used interchangeably with the corresponding ions, and explicit mention thereof is omitted.

Surprisingly, it has been found that the larger differences in solubility between Li₂CO₃ and Na₂CO₃ as compared to the solubilities of Na₂SO₄ and Li₂SO₄ can be used to advantage, in order to achieve a more effective separation. While the solubilities of Na₂SO₄ and Li₂SO₄ differ by about a factor of only 2, Li₂CO₃ is clearly more sparingly soluble than Na₂CO₃, which allows for a more effective separation of the two metals. Therefore, in a preferred embodiment of the inventive process, Li₂CO₃ is separated to obtain a filtrate containing Na₂CO₃.

Within the scope of the process according to the invention, a number of compounds can be employed as the carbonate source. Preferably, the carbonate source is selected from the group consisting of Na₂CO₃, CO₂, NaHCO₃, (NH₄)₂CO₃, (NH₄)HCO₃, and mixtures thereof. The use of CO₂ as a carbonate source has proven particularly advantageous and thus preferable. It can be recovered, for example, from exhaust gases of other processes, and thus directed to sustainable utilization, whereby the emission of CO₂ can be reduced.

The process according to the invention provides that a solution of the sulfate salts of Na and Li is subjected to electrolysis, where it is considered that the sulfate salts are thus converted to the corresponding hydroxides, which can be separated more easily. In this respect, a membrane electrolysis is preferred, especially an electrodialysis and more particularly an electrodialysis with bipolar membranes. Particularly preferred is a multicompartment electrolysis with a cation exchange membrane and an anion exchange membrane.

Within the scope of the process according to the invention, the lithium is recovered as Li₂CO₃, which can be withdrawn from the solution as a solid in a further step. Preferably, the Li₂CO₃ is separated by at least one method selected from the group consisting of sedimentation, filtration, and centrifugation. The separation may include a short washing process, in which the washing liquors can be recycled into the overall process at suitable places.

The process according to the invention allows for an effective separation of Na and Li. If the degree of purity of the Li₂CO₃ obtained should be felt insufficient, the Li₂CO₃ can be subjected to further purification steps. In a preferred embodiment, the Li₂CO₃ obtained is converted to soluble LiHCO₃ in a further step by treating with CO₂. Highly pure Li₂CO₃ can be obtained from this solution by heating the solution containing LiHCO₃. Therefore, an embodiment is preferred in which the solution containing LiHCO₃ is heated to form Li₂CO₃. This purification step offers the advantage that the mother liquor obtained in the separation of Li₂CO₃ and the CO₂ obtained in the formation of the Li₂CO₃ and driven out of the reaction mixture can be recycled into the process, so that a sustainable cycle is formed.

The starting solution A of the process according to the invention can be obtained in a number of methods as applied in recycling processes. The sulfate-containing aqueous solution A is preferably obtained by treating a solution X, wherein said solution X includes Li₂SO₄ and at least one compound MSO₄ in which M is a transition metal, preferably selected from the group consisting of Ni, Co, Mn, Al, and mixtures thereof. For example, this treatment may be performed by using NaOH and optionally further additions of H₂SO₄. It is considered that the metal M is converted to its hydroxide by treating the solution X with NaOH to form Na₂SO₄ as a by-product. Alternatively, the metal can be transferred into the organic phase at first by reactive extraction in the presence of an organic extractant, and subsequently extracted from the organic phase as MSO₄ back into the aqueous phase with sulfuric acid, and thus recycled into the further value-added cycle.

Preferably, within the scope of the process according to the invention, solution X is obtained by treating a suspension Y, which includes at least a compound LiMO₂, with H₂SO₄ and a reducing agent, in which M is a transition metal, preferably one selected from the group consisting of Ni, Co, Mn, Al, and mixtures thereof. Preferably, the reducing agent is selected from the group consisting of H₂O₂ and SO_{2.}

The process according to the invention aims, in particular, at the recovery of Li from lithium ion/polymer batteries. Therefore, an embodiment is preferred in which the suspension including LiMO₂ is obtained from consumed lithium ion batteries and/or production waste from the production thereof. In this way, the process according to the invention provides a comprehensive recycling cycle that allows for an efficient recovery of the lithium built into lithium ion/polymer batteries, and thus is a valuable contribution to the success of the sought concept of electromobility.

Within the scope of the comprehensive approach to recycling, the transition metal hydroxide obtained in the treatment of solution X can also be processed further, for example, for further use as a cathode active material in new batteries. Therefore, in a preferred embodiment of the process according to the invention, the treatment of solution X is carried out in such a way that a transition metal mixed hydroxide NiₓCo_{y}Mn_{z}(OH)₂ is still obtained by adjusting the stoichiometry of the transition metals and precipitation with NaOH. Said adjusting of the stoichiometry can be achieved, for example, by selectively separating or selectively adding one or more of the components of said transition metal mixed hydroxide. In this way, the ratio of Ni:Co:Mn desired in the later cathode material can be adjusted already in the transition metal mixed hydroxide. Within the scope of the current turnaround to nickel-enriched cathode active materials, adjusting the stoichiometry by selectively separating one or more of the components of the transition metal mixed hydroxide is preferred. In a preferred embodiment, the ratio of Ni: Co: Mn in the transition metal mixed hydroxide is 1:1:1, alternatively preferably 8:1:1.

In addition to the recovery of the materials employed, especially the valuable metals, another aspect of a sustainable recycling strategy is the environment-friendly treatment of resources. Among other things, this means that, if possible, chemicals required for the recycling process are also recovered, or recirculated. In the present process, this applies, in particular, to the sulfuric acid, which is necessary for obtaining the solution X. Therefore, an embodiment of the process according to the invention is preferred in which the sulfuric acid obtained in the electrolysis is used at least in part for preparing solution X.

The present invention further relates to a device for carrying out the process according to the invention. The device includes at least one electrolytic unit having at least one supply for introducing solution A and at least one drain for draining solution B.

The present invention is further explained by means of the following Examples, which should by no means be understood as limiting the idea of the invention.

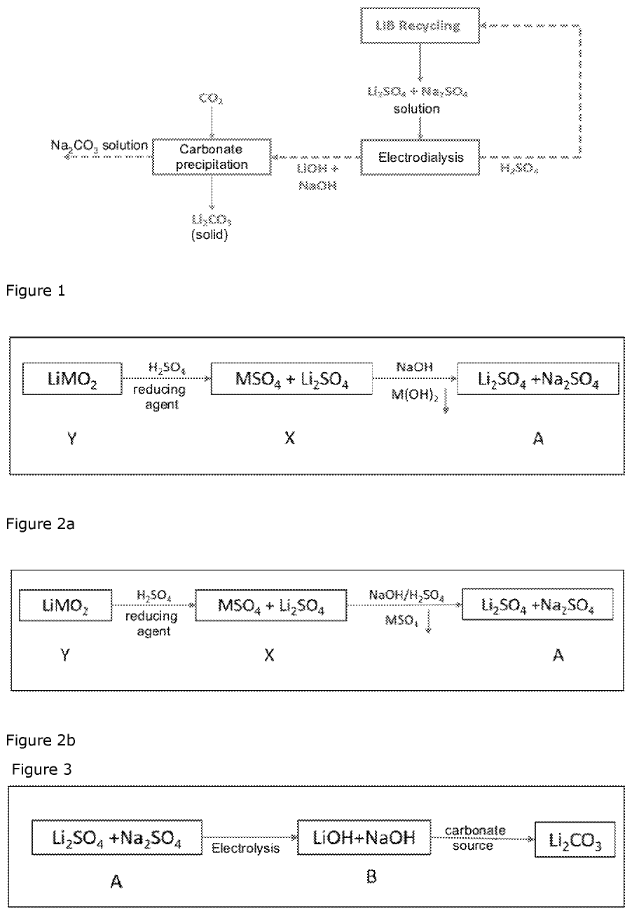

FIG. 1 schematically shows the concept of the process according to the invention, according to which a solution A obtained during the recycling of lithium ion/polymer batteries and containing Li₂SO₄ and Na₂SO₄ is subjected to electrolysis, whereby the sulfates are converted to the corresponding hydroxides, and the Li is separated off as Li₂CO₃ by treatment with CO₂ as a carbonate source, while Na₂CO₃ remains in solution.

FIG. 2a schematically shows how solution A is obtained from a suspension Y obtained during the processing of lithium ion/polymer batteries that contains Li in the form of a lithium/transition metal oxide LiMO₂. The lithium/transition metal oxide is converted to Li₂SO₄ and the corresponding transition metal sulfate MSO₄ (solution X) by treatment with H₂SO₄ and a reducing agent, preferably H₂O₂ or SO₂. The transition metal sulfate can be converted to the corresponding hydroxide M(OH)₂ by treating the solution X with NaOH, and separated off, whereby a solution is obtained that contains Na₂SO₄ and Li₂SO₄ and serves as a starting solution A for the process according to the invention.

According to the scheme shown in FIG. 2b, solution X can further be treated with H₂SO₄ to obtain the transition metal in the form of its sulfate.

FIG. 3 shows the schematic procedure of the process according to the invention, in which a solution A of Li₂SO₄ and Na₂SO₄ is subjected to electrolysis to obtain solution B, from which Li₂CO₃ can then be separated by treating with a carbonate source. In this way, an effective separation of the two ions can be achieved. This listing of claims will replace all prior versions and listings of claims in the application.

1. A process for separating Na and Li ions, characterized in that an aqueous solution A that includes Na₂SO₄ and Li₂SO₄ is subjected to electrolysis to obtain a solution B, and the solution B obtained is treated with a carbonate source to form Li₂CO₃.

2. The process according to claim 1, characterized in that the carbonate source is selected from the group consisting of Na₂CO₃, CO₂, NaHCO₃, (NH₄)₂CO₃, (NH₄)HCO₃, and mixtures thereof.

3. The process according to claim 1, characterized in that said electrolysis is a multicompartment electrolysis with a cation exchange membrane and an anion exchange membrane;

4. The process according to claim 1, characterized in that the Li₂CO₃ formed is separated by at least one method selected from the group consisting of sedimentation, filtration, and centrifugation.

5. The process according to claim 1, characterized in that the LiaCO₃ obtained is converted to soluble LiHCO₃ in a further step by treating with CO₂.

6. The process according to claim 1, characterized in that the aqueous solution A is obtained by treating a solution X, wherein said solution X includes Li₂SO₄ and at least one compound MSO₄, in which M is a transition metal.

7. The process according to claim 6, characterized in that solution X is obtained by treating a suspension Y, which includes at least a compound LiMO₂, with H₂SO₄ and a reducing agent, in which M is a transition metal.

8. The process according to claim 7, characterized in that the compound including LiMO₂ is obtained from consumed lithium ion/polymer batteries and/or production waste from the production thereof.

9. The process according to claim 6. characterized in that a transition metal mixed hydroxide NixMnyCoz(OH)₂ is further obtained when solution X is treated, by adjusting the stoichiometry of the transition metal and precipitating with aqueous sodium hydroxide.

10. The process according to claim 9, characterized in that said adjusting the stoichiometry of the transition metal is effected by selectively separating or adding one or more of the components of the transition metal mixed hydroxide.

11. The process according to claim 6, characterized in that the sulfuric acid obtained in the electrolysis is used at least in part for preparing solution X.

12. A device for carrying out a process according to claim 1, comprising an electrolytic unit having at least one supply for introducing solution A and at least one drain for draining solution B.

13. The process according to claim 3, wherein the anion exchange membrane is an electrodialysis.

14. The process according to claim 3, wherein the anion exchange membrane is an electrodialysis with bipolar membranes.

15. The process according to claim 6, wherein the transition metal is selected from the group consisting of Ni, Co, Mn, Al, and mixtures thereof.

16. The process according to claim 7, wherein the transition metal is selected from the group consisting of Ni, Co, Mn, Al, and mixtures thereof.
